(19) United States
(12) Patent Application Publication
(10) Pub. No.: US 2010/0034545 A1
(43) Pub. Date: Feb. 11, 2010

(54) DEVELOPER SUPPLY CARTRIDGE, IMAGE FORMING METHOD, AND IMAGE FORMING APPARATUS

(75) Inventor: Yosuke IMAMURA, Kanagawa (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/535,481

(22) Filed: Aug. 4, 2009

Related U.S. Application Data
(60) Provisional application No. 61/086,763, filed on Aug. 6, 2008.

(51) Int. Cl. G03G 15/08; G03G 21/16

(52) U.S. Cl. 399/62; 399/262; 399/254; 399/256; 399/111

(57) ABSTRACT

A developer supply cartridge including toner, carrier for charging the toner, a case housing the toner and the carrier, an openable partition dividing an inside of the case into a first area filled with the toner and a second area filled with the carrier, and a supply port provided in the first area, the supply port for discharging the developer including the toner and the carrier from the case.

### CROSS-REFERENCE TO RELATED APPLICATION

This application is based upon and claims the benefit of priority from the prior U.S. Patent Application 61/086,763 filed on Aug. 6, 2008, the entire contents of which are incorporated herein by reference.

### TECHNICAL FIELD

The present invention relates to a developer supply cartridge used in image forming apparatuses that form images in an electrophotographic system such as a copying machine and a printer, an image forming method, and an image forming apparatus.

### BACKGROUND

In an image forming apparatus of the electrophotographic system, a two-component developer including a toner and a magnetic carrier for charging the toner is used. In a developing device in which such a two-component developer is used, since the toner is consumed according to developing operation, the toner equivalent to a consumed quantity is supplied. However, concerning the carrier, because of deterioration thereof, it is difficult to maintain an initial state, for example, to secure desired chargeability.

Therefore, in order to realize further extension of the life of the developer in the developing device in which such a two-component developer is used, a self-refresh system is used. As disclosed in JP-A-2003-15418, the self-refresh system is a system for supplying a new carrier together with a toner simultaneously with discharging a carrier in a developer deteriorated according to developing operation. Since the carrier is sequentially replaced, it is possible to extend the life of the developer compared with that in the past.

In a developing device used in such a self-refresh system, in order to supply the toner and the carrier, a developer supply cartridge is used. In the developer supply cartridge, the toner and the carrier having different specific gravities are filled. Therefore, in storage, transportation, and use of the developer supply cartridge, it is necessary to set various restrictions.

Specifically, the developer supply cartridge is stored in a case and packaged and then loaded and transported to a user in a state in which the toner and the carrier are mixed. The carrier having specific gravity larger than that of the toner may be deposited at the bottom of the developer supply cartridge because of vibration and the like during the transportation.

Therefore, when a developer supply port is faced down, the carrier deposited at the bottom is discharged all at once at an initial stage and the carrier is suddenly supplied to the developing device. When the carrier is suddenly supplied, the discharge of the developer in the developing device is late and the toner density in the developing device falls. According to the fall in the toner density, developer supply operation to the developing device is continued. As a result, a developer quantity in the developing device becomes extremely excessive and the volume density of the developer increases to exceed the capacity of the developing device. As a result, developer leakage (blowout) into an image forming apparatus, image blur, and the like are caused.

The developer leakage (blowout) is a phenomenon in which, when the discharge of the developer is late and the developer is supplied in a quantity exceeding the capacity of the developing device, the developer quantity in the developing device reaches a saturated state, the pressure in the developing device rises, and the developer blows out from, for example, a gap between a case (a lower unit) and a sleeve unit (an upper unit) of the developing device.

The image blur is a phenomenon in which, when the developer is supplied into the developing device in a quantity exceeding the capacity of the developing device, since carriability of the developer in the developing device substantially falls because of an increase in the volume density of the developer, the developer is not sufficiently carried onto a sleeve and an image is blurred.

Therefore, it is necessary to transport and store the developer supply cartridge in a stacked state with the supply port side thereof facing up, i.e., when the developer supply cartridge has a carrying paddle or an auger, a side on which the carrying paddle or the auger is arranged facing up. Further, before use, it is necessary to sufficiently shake the developer supply cartridge to uniformly spread the developer in advance.

However, in loading, it is difficult to manage directions and transportation forms of all developer supply cartridges. Further, the uniform spread of the developer by predetermined handling before use such as sufficient shaking of the developer supply cartridge before use is a burden on a user. Therefore, this needs to be prevented.

### SUMMARY

According to an aspect of the present invention, there is provided a developer supply cartridge including: toner; carrier for charging the toner; a case housing the toner and the carrier; an openable partition dividing an inside of the case into a first area filled with the toner and a second area filled with the carrier; and a supply port provided in the first area, the supply port for discharging the developer including the toner and the carrier from the case.

According to another aspect of the present invention, there is provided an image forming method including: setting, in a developing device including a developer container, a developer supply cartridge in which a toner for developing an electrostatic latent image formed on an image bearing member is filled in a first area having a supply port, a carrier for charging the toner is filled in a second area, and the first area and the second area are divided by a partition; supplying a developer including the toner and the carrier, which are mixed when the partition is opened, from the developer supply cartridge to the developer container through the supply port; and supplying the developer, which is supplied to the developer container, to the image bearing member having the electrostatic latent image formed thereon to develop the electrostatic latent image and form an image.

According to still another aspect of the present invention, there is provided an image forming apparatus including: an image bearing member on which an electrostatic latent image is formed; a developing device that develops the electrostatic latent image formed on the image bearing member, the developing device including a developer container in which a developer including a toner for developing the electrostatic latent image formed on the image bearing member and a carrier for charging the toner is stored; and a developer supply cartridge that is set in the developing device and used for supplying the developer to the development container, the developer supply cartridge including a case in which the toner and the carrier are filled, an openable partition that divides the inside of the case into a first area in which the toner is filled and a second area in which the carrier is filled, and a supply port that is provided in the first area and is used for discharging the developer including the toner and the carrier from the case and supplying the developer to the developing device.

It is to be understood that both the forgoing general description and the following detailed description are exemplary and explanatory only and are not restrictive of the invention, as claimed.

### DESCRIPTION OF THE DRAWINGS

The accompanying drawings, which are incorporated in and constitute a part of this specification, illustrates an embodiment of the invention and together with the description, serve to explain the principles of the invention.

FIG. 1 is a diagram of a developer supply cartridge according to an embodiment of the present invention;

FIG. 2 is a sectional view taken along a line A-A′ of FIG. 1;

FIGS. 3 to 5 are schematic diagrams of other developer supply cartridges according to the embodiment;

FIG. 6 is another sectional view taken along the line A-A′ of FIG. 1;

FIG. 7 is a schematic diagram of another developer supply cartridge according to the embodiment;

FIG. 8 is a diagram of an image forming apparatus according to the embodiment;

FIG. 9 is a schematic diagram of an image forming unit according to the embodiment;

FIG. 10 is a sectional view taken along a line B-B′ of FIG. 9;

FIG. 11 is a partial sectional view taken along a line C-C′ of FIG. 10; and

FIG. 12 is a table of evaluation results of examples and comparative examples according to the embodiment.

### DETAILED DESCRIPTION

Reference will now be made in detail to the present embodiment of the invention, an example of which is illustrated in the accompanying drawings.

A developer supply cartridge according to an embodiment of the present invention is shown in FIG. 1. In a developer supply cartridge 10, an area 11a in which a toner is filled and an area 11b in which a carrier is filled are provided in a case 11 of, for example, a rectangular parallelepiped shape (a box shape). The areas 11a and 11b are vertically divided by a bag-like partition 12. In the area 11a, a supply port 13 for supplying a developer including the toner and the carrier to a developing device in an image forming apparatus explained later is provided. In the following explanation, directions such as the vertical direction indicate directions in a state in which the developer supply cartridge is attached to the developing device.

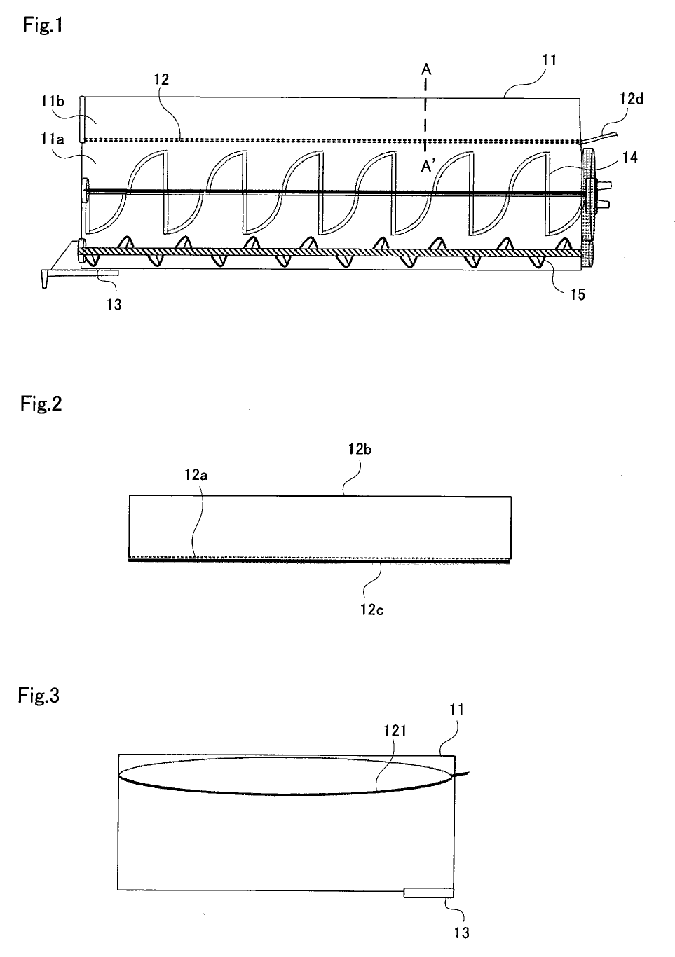

A section taken along a line A-A′ of FIG. 1 is shown in FIG. 2. The partition 12 includes a partition main body 12b of a bag shape in which an opening 12a having a diameter equal to or smaller than 10 mm and, more preferably, about 5 mm is uniformly formed in a section set in contact with the area 11a and a flat partition film 12c that seals the opening 12a. The partition film 12b is bonded with the partition main body 12b by an adhesive or the like and connected to an exposed section 12d on the outside of the case 11.

In the area 11a, an agitating paddle 14 for agitating the developer and an auger 15 for sending the agitated developer to the supply port 13 are provided. The agitating paddle 14 and the auger 15 are arranged not to come into contact with the partition 12.

Before (or after) such a developer supply cartridge 10 is attached to the developing device explained later, the section 12d exposed to the outside is pulled to remove the partition film 12c, whereby the seal is removed. The carrier filled in the area 11b from the opening 12a is mixed in the area 11a.

In a state in which the carrier is mixed in the toner in this way, the developer supply cartridge 10 is attached to the developing device explained later. The carrier and the toner are mixed, agitated by the agitating paddle 14, and sent to the supply port 13 by the auger 15. The developer is supplied to the developing device.

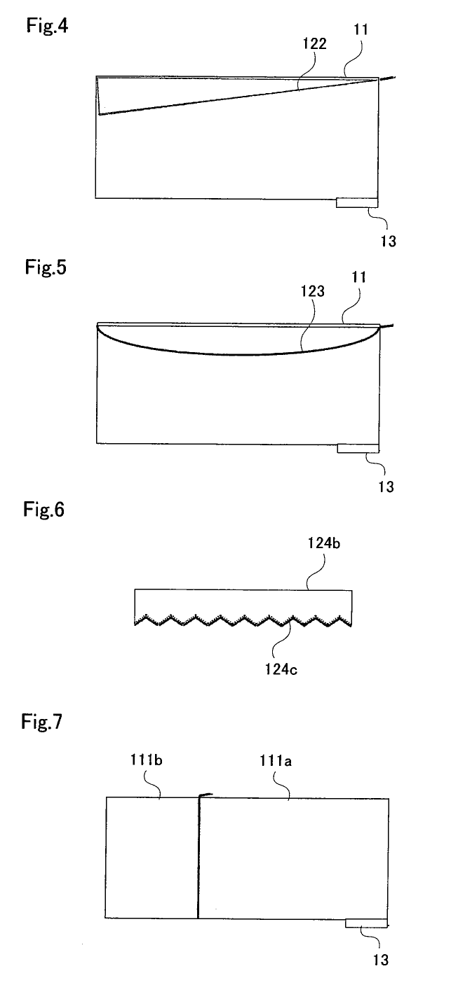

The developer supply cartridge 10 is not limited to such a configuration. For example, the partition 12 does not always have to be formed in the horizontal direction. As shown in FIG. 3, a sectional shape of a partition 121 maybe an elliptical shape. As shown in FIG. 4, a sectional shape of a partition 122 may be an inclined shape. Further, as shown in FIG. 5, a sectional shape of a partition 123 may be bent in an arch shape.

The partition 12 is not always limited to the bag shape. The partition 12 may be formed in any shape as long as the toner and the carrier can be separately stored, the partition 12 is opened when at least a part thereof is removed, and the toner and the carrier can be mixed.

The partition film 12c (and the partition main body 12a in a section opposed to the partition film 12c) does not always have to be flat. As shown in FIG. 6, the section along the line A-A′ of FIG. 1, a partition film 124c of a partition main body 124b may be a peak-and-valley shape. A shape of the opening 12a does not always have to be a circular shape and may be a square shape or a slit shape.

The partition film 12c does not always have to be provided. The partition 12 may be opened by being entirely pulled out to the outside from an end thereof. The carrier is discharged from opened the other end. The toner and the carrier can be mixed. In this case, an opening at the end is equal to or smaller than 20 mm and, more preferably, about 10 mm. The opening can be formed by sticking a sticker to the other end from an outer side and peeling off the sticker or bonding the other end (a section left as the very end when the partition 12 is pulled out) with the case and pulling out the partition 12 to peel off a bonded section.

The case does not always have to be formed in the rectangular parallelepiped shape (the box shape) and may be a bottle shape (a cylinder shape) without an agitating paddle or an auger arranged therein. In this case, since it is unnecessary to take into account interference between the partition and the agitating paddle or the auger, as shown in FIG. 7, an area 111a and an area 111b can be arranged adjacent to each other in the horizontal direction.

With such a developer supply cartridge, it is possible to prevent the carrier having specific gravity larger than that of the toner from being deposited at the bottom because of vibration and the like during transportation. It is possible to prevent developer leakage (blowout) into the image forming apparatus and image blur without strictly managing handling during transportation and storage and before use.

Such a developer supply cartridge is set and used in, for example, a color printer as an image forming apparatus to which a self-refresh system is applied.

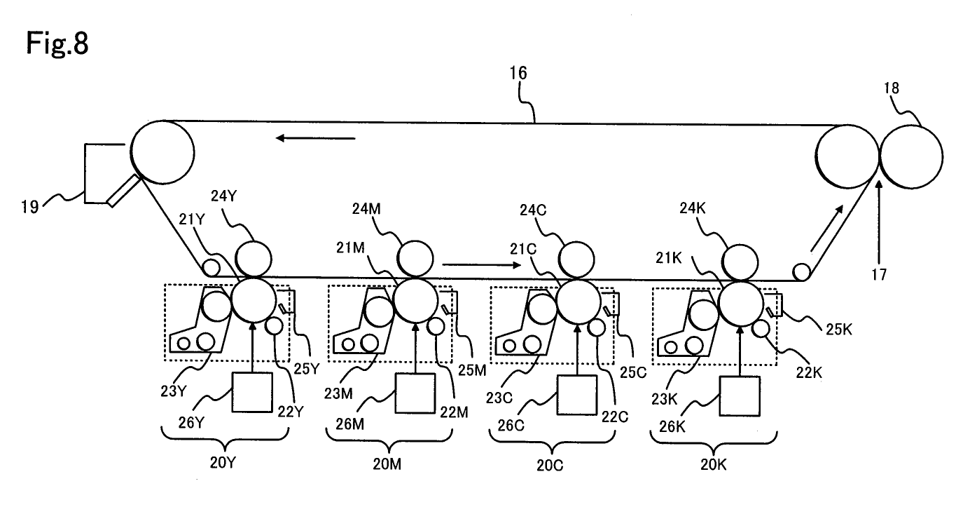

A diagram of a quadruple tandem color printer as such an image forming apparatus is shown in FIG. 8. As shown in FIG. 8, along a conveying direction (an arrow direction) of an intermediate transfer belt 16, a secondary transfer roller 18 for transferring an image on the intermediate transfer belt 16 onto a transfer medium 17, a cleaner 19 for removing a toner remaining on the intermediate transfer belt 16, and image forming units 20Y, 20M, 20C, and 20K are arranged.

The image forming units 20Y, 20M, 20C, and 20K respectively include photoconductive drums 21Y, 21M, 21C, and 21K as image bearing members (electrostatic latent image bearing members). As a photoconductive member, a publicly-known photoconductive member such as a positively-charged or negatively-charged OPC (Organic Photoconductor), amorphous silicon, or the like is used.

The image forming units 20K, 20M, 20C, and 20K respectively further include, around the photoconductive drums 21Y, 21M, 21C, and 21K, chargers 22Y, 22M, 22C, and 22K as charging means, developing devices 23Y, 23M, 23C, and 23K having developing rollers as developing members and respectively having developers including toner particles and carrier particles of yellow, magenta, cyan, and black stored therein, primary transfer rollers 24Y, 24M, 24C, and 24K as transfer means, and cleaners 25Y, 25M, 25C, and 25K as cleaning means. These devices are respectively arranged along rotating directions of the photoconductive drums 21Y, 21M, 21C, and 21K corresponding thereto.

The primary transfer rollers 24Y, 24M, 24C, and 24K are disposed on the inner side of the intermediate transfer belt 10 and nip the intermediate transfer belt 10 in conjunction with the photoconductive drums 21Y, 21M, 21C, and 21K corresponding thereto. Exposing devices 26Y, 26M, 26C, and 26K are respectively arranged such that exposure points are formed on outer circumferential surfaces of the photoconductive drums 21Y, 21M, 21C, and 21K between the chargers 22Y, 22M, 22C, and 22K and the developing devices 23Y, 23M, 23C, and 23K. On the outer side of the intermediate transfer belt 16, the secondary transfer roller 18 is arranged to be set in contact with the intermediate transfer belt 16.

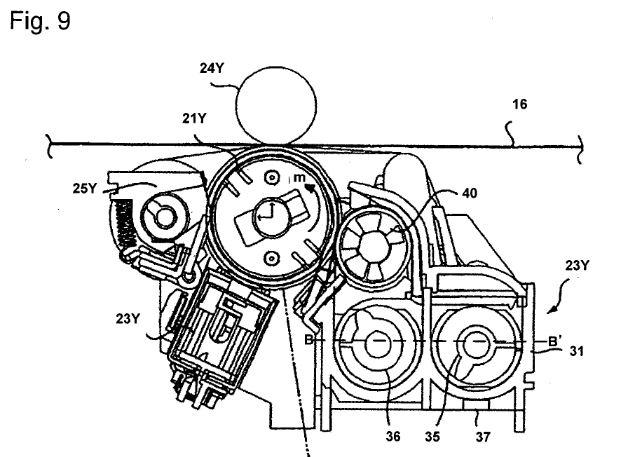

A schematic diagram of an image forming unit is shown in FIG. 9. The image forming unit 20Y is explained as an example. However, the same configuration is adopted in the image forming units 20M, 20C, and 20K.

The charger 22Y, the developing device 23Y to which the self-refresh system is applied, the primary transfer roller 24Y, and the cleaner 25Y are arranged around the photoconductive drum 21Y. The developing device 23Y includes a case 31 as a developer container in which a developer 30 is stored, a developing roller 32 as a developing member, a first mixer 35 and a second mixer 36 as agitating and carrying devices that agitate the developer 30 and circulatingly carry the developer 30 in the case 31, and a toner density sensor 37 as a toner-density detecting unit that detects toner density in the developer stored in the case 31.

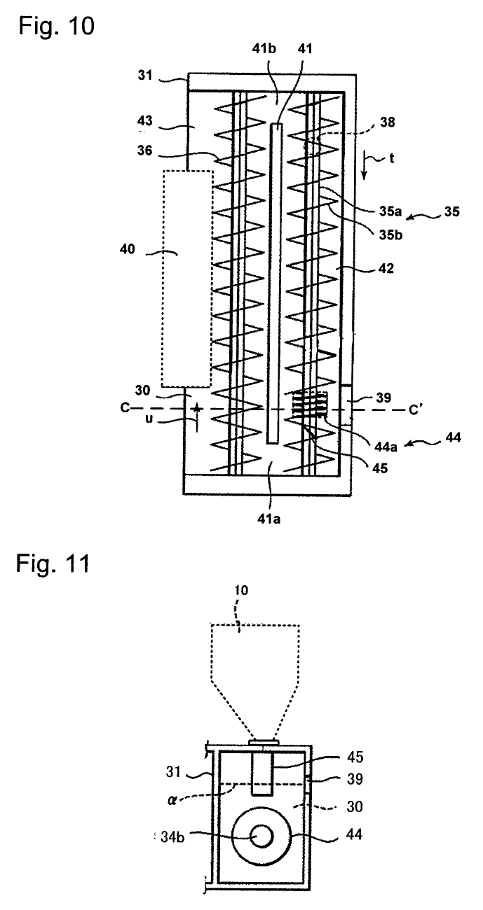

A sectional shape taken along a line B-B′ of FIG. 9 is shown in FIG. 10. A partial sectional view taken along a line C-C′ of FIG. 10 is shown in FIG. 11. A supply port 38 for the developer 30 is set in an upper section of the case 31. The developer supply cartridge 10 for supplying the developer 30 to the developing device 23Y is attached to an upper section of the supply port 38. On a side of the case 31, a discharge port 39 as a developer discharge section for discharging the developer 30 made redundant because of the supply of the developer 30 into the case 31 is arranged. A developing roller 40 that supplies the developer 30 onto the photoconductive drum 21Y is provided.

The case 31 is partitioned by a partition plate 41 into a first agitating passage 42 in which the first mixer 35, is arranged and a second agitating passage 43 in which the second mixer 36 is arranged. These mixers circulatingly carries the developer 30, respectively. The first agitating passage 42 and the second agitating passage 43 communicate with each other in a first communicating section 41a and a second communicating section 41b. The first mixer 35 includes a shaft 35a and vanes 35b. In the shaft 35a, a discharge mixer 44 including vanes 44a having a diameter and a pitch smaller than those of the vanes 35b is arranged in a position opposed to the discharge port 39. On a downstream side of the discharge port 39, a contact pivoting plate 45 as an adjusting member for suppressing fluctuation in a discharge amount of the developer 30 due to an environmental change is arranged such that a lower end thereof is at predetermined height.

An image is formed, for example, as explained below by using such an image forming apparatus. The charger 22Y negatively charges the photoconductive drum 21Y uniformly. The charged photoconductive drum 21Y is exposed to light by the exposing device 26Y according to image information. An electrostatic latent image is formed on the photoconductive drum 21Y.

In the developing device 23Y, the developer 30 in the case 31 is circulatingly carried in directions “t” and “u” by the first mixer 35 and the second mixer 36, respectively, through the first agitating passage 42 and the second agitating passage 43 that communicate with each other in the first communicating unit 44a and the second communicating unit 44b. The developer 30 is supplied onto the photoconductive drum 21Y by the developing roller 40. The electrostatic latent image on the photoconductive drum 21Y is reversely developed by the developing device 23Y. A toner image is formed on the photoconductive drum 21Y.

A bias (+) having polarity opposite to charging polarity of the toner is applied to the primary transfer roller 24Y by a power supply (not shown in the figure). A transfer electric field is formed between the photoconductive drum 21Y and the primary transfer roller 24Y. As a result, the toner image on the photoconductive drum 21Y is primarily transferred onto the intermediate transfer belt 16 by the transfer electric field when the toner image passes between the photoconductive drum 21Y and the primary transfer roller 24Y. After being cleaned by the cleaner 25Y, the photoconductive drum 21Y after the transfer repeats the process of charging, exposure, and development.

The development is performed in this way and the toner in the developer 30 is consumed. When a fall in the toner density of the developer 30 is detected by the toner density sensor 37, a new developer 30 is supplied from the developer cartridge 10.

The developer 30 made redundant by the supply of the new developer 30 is discharged from the discharge port 39. Since the vanes 45a of the discharge mixer 45 have the diameter and the pitch smaller than those of the vanes 35b of the first mixer 35, the flow speed of the developer 30 is reduced. When the flow speed of the developer 30 is reduced, the developer 30 is held up in a position opposed to the discharge port 39. The developer 30 swelled to a broken line a from the lower end of the discharge port 39 by being held up is discharged from the discharge port 39.

The swelling height of the developer 30 slightly fluctuates because of an environmental change such as humidity. Therefore, the fluctuation in the discharge amount is suppressed by the contact pivoting plate 45 as the adjusting member. Further, an environment detecting unit that detects an environment state such as humidity may be set. The discharge amount of the developer 30 from the discharge port 39 may be adjusted by the adjusting member on the basis of a detection result of the environment detecting unit. In this way, the new developer is supplied by the self-refresh system according to the consumption of the toner and the deteriorated developer equivalent to a supplied quantity is discharged.

The toner image is formed in the image forming unit 20Y in this way. According to timing of the toner image formation in the image forming unit 20Y, the same process is performed in the image forming unit 20M, 20C, and 20K. Magenta, cyan, and black toner images formed on the photoconductive drums 21M, 21C, and 21K of the image forming units 20M, 20C, and 20K are sequentially primarily transferred onto the intermediate transfer belt 16.

The transfer medium 17 is conveyed from a cassette (not shown in the figure) and delivered to the intermediate transfer belt 16 by an aligning roller (not shown in the figure) to be timed to coincide with the toner image on the intermediate transfer belt 16.

A bias (+) having polarity opposite to the charging polarity of the toner is applied to the secondary transfer roller 18 by the power supply (not shown in the figure) As a result, the toner image on the intermediate transfer belt 16 is transferred onto the transfer medium 17 by a transfer electric field formed between the intermediate transfer belt 16 and the secondary transfer roller 18. A fixing device (not shown in the figure) for fixing the toner transferred on the transfer medium 17 is disposed. A fixed image is obtained by causing a sheet to pass through the fixing device.

A part of the toner remaining on the intermediate transfer belt 16 without being completely transferred onto the transfer medium 17 (a transfer residual toner) is cleaned by the cleaner 19.

In the example explained above, the image forming units 20Y, 20M, 20C, and 20K are arranged in color order of yellow, magenta, cyan, and black. However, this color order is not specifically limited. In a cleanerless process in which a cleaner, is not used, the transfer residual toner is collected simultaneously with development. When the self-refresh system is not used, the developer 30 is replaced at a predetermined cycle without being automatically supplied and discharged.

The present invention is specifically explained below with reference to examples.

### EXAMPLE 1

The box-type developer supply cartridge including the carrying paddle and the auger shown in FIG. 1 was used to fill the toner in the area 11a (in a lower section) and fill the carrier in the area 11b (in an upper section) such that the toner density in the developer was, for example, equal to or lower than 35 wt % and equal to or higher than 15 wt %. Before the developer supply cartridge was attached to the developing device, the partition film was pulled out from the section exposed to the outside and the partition was opened. Then, the toner and the carrier were lightly agitated.

In this state, the developer supply cartridge was attached to a developer of a multifunction peripheral e-STUDIO6530c manufactured by Toshiba, a part on an apparatus body side of which was remodeled. The developer supply cartridge was evaluated as explained below.

Image Defect Evaluation

After forced toner supply operation was performed by using a yellow toner, charts were created on two-hundred A3 sheets at a print ratio 25% and image blur at this point was evaluated. When no deficiency is found, an evaluation score is A. When a deficiency is found, an evaluation score is C.

Developer Blowout Evaluation

After the forced toner supply operation was performed by using the yellow toner, charts were created on two-hundred A3 sheets at a print ratio 30% and blowout (leakage) of the developer was evaluated. When no deficiency is found, an evaluation score is A. When a deficiency is found, an evaluation score is C.

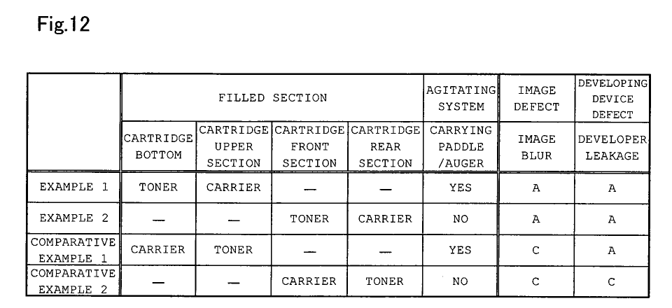

As shown in FIG. 12, both the image defect evaluation and the developer blowout evaluation indicated satisfactory characteristics.

### EXAMPLE 2

The bottle-type developer supply cartridge not including the carrying paddle and the auger shown in FIG. 7 was used to fill the toner in the area 111a (in a front section) and fill the carrier in the area 111b (in a rear section) such that the toner density in the developer is, for example, equal to or lower than 35 wt % and equal to or higher than 15 wt % as in Example 1. Before the developer supply cartridge was set in the developing device, the partition film was pulled out from the section exposed to the outside and the partition was opened. Then, the toner and the carrier was lightly agitated.

In this state, the developer supply cartridge was set in the developer and evaluated as in Example 1.

As shown in FIG. 12, both the image defect evaluation and the developer blowout evaluation indicated satisfactory characteristics.

### COMPARATIVE EXAMPLE 1

The box-type developer supply cartridge, was used as in Example 1 to fill the carrier in the area 11a (in the lower section) and fill the toner in the area 11b (in the upper section) in a manner opposite to Example 1. The developer supply cartridge was evaluated as in Example 1.

As shown in FIG. 12, although developer blowout (leakage) did not occur, when the developer supply cartridge was set in the developing device and the developer was supplied to the developing device, a large quantity of the carrier was supplied and image blur occurred.

### COMPARATIVE EXAMPLE 2

The bottle-type developer supply cartridge was used as in Example 2 to fill the carrier in the area 111a (in the front section) and fill the toner in the area 111b (in the rear section) in a manner opposite to Example 1. The developer supply cartridge was evaluated as in Example 1.

As shown in FIG. 12, when the developer supply cartridge was set in the developing device and the developer was supplied to the developing device, a large quantity of the carrier was supplied and image blur and developer blowout (leakage) occurred.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A developer supply cartridge comprising:
toner;
carrier for charging the toner;
a case housing the toner and the carrier;
an openable partition dividing an inside of the case into a first area filled with the toner and a second area filled with the carrier; and
a supply port provided in the first area, the supply port for discharging the developer including the toner and the carrier from the case.

2. The cartridge according to claim 1, wherein the first area is in a lower section and the second area is in an upper section in a state of the developer supply cartridge attached to the developing device.

3. The cartridge according to claim 2, further comprising a carrying paddle or an auger in the case.

4. The cartridge according to claim 2, wherein an interface between the first area and the second area is flat, inclined, or bent in a state of the developer supply cartridge attached to the developing device.

5. The cartridge according to claim 1, wherein the first area and the second area are provided to be adjacent to each other in a horizontal direction in a state of the developer supply cartridge attached to the developing device.

6. The cartridge according to claim 1, wherein the partition is openable by removing at Least a part of the partition to an outside of the case.

7. The cartridge according to claim 1, wherein the partition leads to a section exposed to an outside of the case.

8. The cartridge according to claim 1, wherein the partition includes a first section having an opening and a second section sealing the opening.

9. The cartridge according to claim 1, wherein the partition is formed in a bag shape.

10. An image forming method comprising:
attaching a developer supply cartridge to a developing device including a developer container, the developer supply cartridge having a first area having a supply port and a second area divided by a partition, the first area filled with a toner for developing an electrostatic latent image formed on an image bearing member, the second area filled with a carrier for charging the toner;
supplying a developer including the toner and the carrier mixed by opening the partition from the cartridge to the developer container through the supply port; and
supplying the developer to the image bearing member having the electrostatic latent image formed on the image bearing member to form an image.

11. The method according to claim 10, wherein the toner and the carrier are mixed and carried by a carrying paddle or an auger provided in the case.

12. The method according to claim 10, wherein the partition is opened before,attaching the cartridge to the developing device.

13. The method according to claim 12, wherein the developer is agitated and supplied to the developing device after the partition is opened.

14. The method according to claim 10, wherein the partition is opened when at least a part of the partition is removed to an outside of the case.

15. The method according to claim 10, wherein the first area is in a lower section and the second area is in an upper section in a state of the developer supply cartridge attached to the developing device.

16. The method according to claim 10, wherein the first area and the second area are adjacent to each other in a horizontal direction in a state of the developer supply cartridge attached to the developing device.

17. The method according to claim 10, further comprising:
detecting density of the toner in the developing device;
supplying the developer from the cartridge to the developer container on the basis of the density of the toner; and
discharging a part of the developer from the developer container on the basis of a quantity of the developer supplied.

18. An image forming apparatus comprising:
an image bearing member forming a static latent image on the image bearing member;
a developing device for developing the electrostatic latent image formed on the image bearing member, the developing device including a developer container for storing a developer including a toner for developing the electrostatic latent image formed on the image bearing member and a carrier for charging the toner; and
a developer supply cartridge attached to the developing device, for supplying the developer to the development container, the cartridge including:
a case for being filled with the toner and the carrier;
an openable partition dividing an inside of the case into a first area filled with the toner and a second area filled with the carrier; and
a supply port provided in the first area, the supply port for discharging the developer including the toner and the carrier from the case and supplying the developer to the developing device.

19. The apparatus according to claim 18, wherein a carrying paddle or an auger is provided in the case.

20. The apparatus according to claim 18, further comprising:
a developing member for supplying the developer in the developer container to the image bearing member;
an agitating and carrying member for agitating the developer and for circulatingly carrying the developer in the developer container; and
a toner-density detecting unit for detecting density of the toner in the developer.
